(19) United States
(12) Patent Application Publication
(10) Pub. No.: US 2014/0129334 A1
(43) Pub. Date: May 8, 2014

(54) METHOD AND SYSTEM FOR MODELING CONSUMER ACTIVITY AREAS BASED ON SOCIAL MEDIA AND MOBILE DATA

(71) Applicant: PITNEY BOWES INC., Stamford, CT (US)

(72) Inventors: QUIJU GU, Trumbull, CT (US); JUN ZHANG, Hamden, CT (US)

(73) Assignee: Pitney Bowes Inc., Stamford, CT (US)

(21) Appl. No.: 13/667,084

(22) Filed: Nov. 2, 2012

(51) Int. Cl. G06Q 30/02

(52) U.S. Cl. 705/14.58

(57) ABSTRACT

A system and method for modeling consumer activity based on social media and mobile activity data is provided. The location of a consumer and time at which the consumer is present at such location can be obtained using social media and mobile activity data. This data can be analyzed to identify areas frequented by a consumer, and those areas can be classified into different groups based on, for example, the time of the day, the day of week, and other information that can be obtained from the social media and mobile activity data. The resulting analysis can provide an estimated home area and work area, and other insights into the consumer (e.g., where the consumer travels). This consumer activity can be used by a business to provide relevant, targeted advertising to potential customers based on the models obtained from the social media and mobile activity data.

### FIELD OF THE INVENTION

The invention disclosed herein relates generally to marketing systems, and more particularly to a method and system for modeling consumer's activity areas based on social media and mobile activity data to enable a business to better communicate with potential customers.

### BACKGROUND OF THE INVENTION

In today's highly competitive business world, advertising to customers, both potential and previous, is a necessity. Businesses are always looking for ways to increase revenue, and increasing its sales to customers through advertising plays a large part in many business's plans for growth. Advertising has shown to be an effective method to inform, persuade or remind target buyers of the business' goods, services or goodwill, with the ultimate goal being that an advertisement will result in the sale of the goods or services.

Due to the costs associated with marketing campaigns, it is not possible for a business to send advertising material to an unlimited number of potential customers. It would be beneficial for a business to target its advertising to those people that may actually be potential customers, and to provide those potential customers with advertisements that are relevant and timely.

### SUMMARY OF THE INVENTION

The present invention provides a system and method for modeling consumer activity based on social media and mobile activity data. The location of a consumer and time at which the consumer is present at such location can be obtained using social media and mobile activity data. This data can be analyzed to identify areas frequented by a consumer, and those areas can be classified into different groups based on, for example, the time of the day, the day of week, and other information that can be obtained from the social media and mobile activity data. The resulting analysis can provide an estimated home area and work area, and other insights into the consumer (e.g., where the consumer travels). This consumer activity can be used by a business to provide relevant, targeted advertising to potential customers based on the models obtained from the social media and mobile activity data. The present invention utilizes social media and mobile data to help a business to augment its customer profiling capabilities and provide a new source of customer insight.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like of corresponding parts.

FIG. 1 illustrates a block diagram of a system according to an embodiment of the present invention.

FIG. 2 illustrates in flow diagram form the processing performed according to an embodiment of the present invention.

FIG. 3 illustrates an example of clustering results utilizing social media data according to an embodiment of the present invention.

FIG. 4 illustrates an example of a “home area” polygon according to an embodiment of the present invention.

FIG. 5 illustrates an example of a heat map using the “home area” polygon illustrated in FIG. 4 according to an embodiment of the present invention.

### DETAILED DESCRIPTION OF THE PRESENT INVENTION

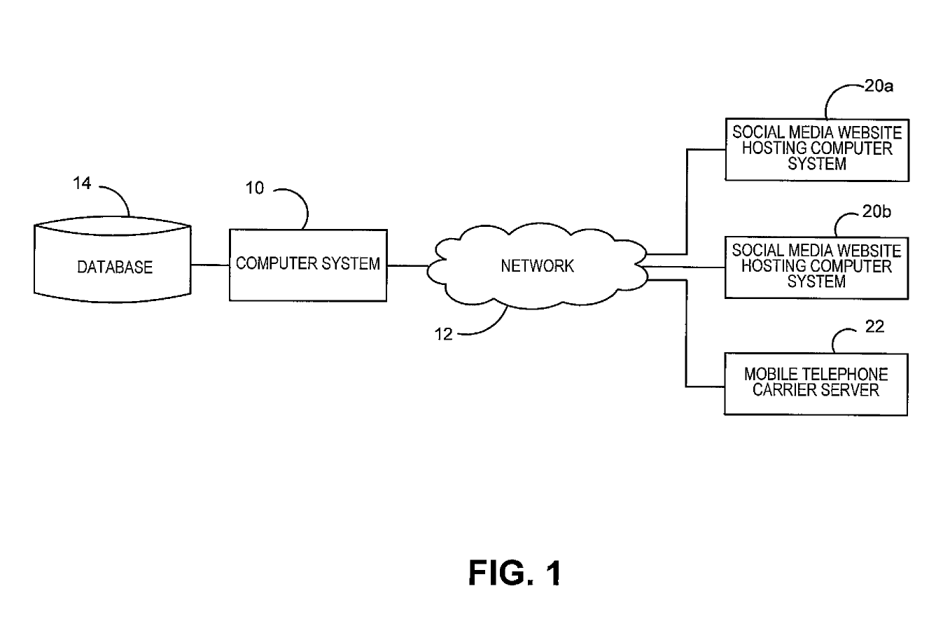

In describing the present invention, reference is made to the drawings, wherein there is seen in FIG. 1 a block diagram of a system according to an embodiment of the present invention. As illustrated in FIG. 1, a computer system 10 is in electronic communication with a network 12, which may be, for example, the Internet, one or more private computer networks, or any combination thereof. Computer system 10 may be specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by the computer system 10. The computer system 10 is also in electronic communication with a database 14. Database 14 stores information including, for example and without limitation, social media information obtained as described below. One or more social media website hosting computer systems (20a, 20b), are coupled to the network 12, along with one or more (only one shown) mobile telephone carrier server 22. Each hosting computer system can host one or more social media websites. Additionally, a customer computer system 30, which may be, for example, a personal computer or the like, is coupled to the network 30 and allows customers to access and use social media websites hosted by the computer systems 25a-25n. It should be understood that the number of social media website hosting computer systems 25 and customer computer systems 30 are not limited in number, and any number can be connected to the network 20.

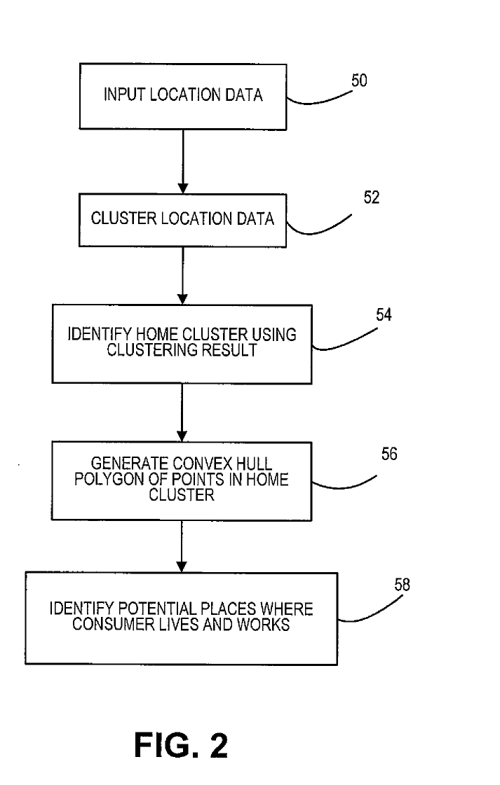

FIG. 2 illustrates in flow diagram form the processing performed to model consumer activity areas according to an embodiment of the present invention. The processing as illustrated in FIG. 2 is preferably performed by the computer system 10 as illustrated in FIG. 1 operating a computer program as described herein. In step 50, inputs in the form of location history data points of a person are provided to the computer system 10. Each location history data point indicates a time and location where a person checked-in with a service, such as, for example, a social media service provider or mobile telephone carrier service provider. These inputs can be obtained, for example, from the social media website hosting computer systems 20a, 20b, and/or the mobile telephone carrier server 22. Alternatively, such inputs could be obtained from media on which this information is stored that are provided by social media hosts or mobile telephone carriers. With the wide adoption of smart phones and social media services, consumers provide rich location based information to service providers such as, for example, check-in history data points of a person using location based services like Foursquare or Facebook Place, GPS information embedded in pictures and tweets that a person shared on-line via Instagram, Flickr, Facebook or Twitter, GPS information provided to mobile application developers, and tracking of a subscriber's location by a mobile telephone carrier using cell phone tower tracking when a subscriber make a call or send a message.

The data points include a time that is preferably in the form of a date and time of day, as well as a location. The location can be provided as longitude and latitude coordinates, or also provided as clear text, e.g., an address such as 27 Waterview Drive, Shelton, Conn. In the latter situation, the address will be geocoded into a longitude/latitude coordinate. Such data can be stored in the database 14 or a memory device (not shown) within computer system 10. An example of a simplified location history is illustrated in Table 1.

TABLE 1

| ID | Time | Longitude | Latitude |
|---|---|---|---|
| 1 | 2012-05-14-11:18:24 | −73.0821091 | 41.29425307 |
| 2 | 2012-05-12-13:01:30 | −72.99072236 | 41.27610068 |
| 3 | 2012-05-12-13:00:45 | −72.99071083 | 41.27613229 |

In step 52, computer system 10 processes the location history input data to spatially cluster the data points. Clustering, as is well known, is the process of assigning a set of objects into groups (called clusters) so that objects in the same cluster are similar (in some sense or another) to each other, and the objects in different clusters are different than each other. There are multiple processes that can be used to spatially cluster a set of location points. The selection of an appropriate clustering process and parameter settings (including values such as the similarity measurement to use, process stop criteria, and the number of expected clusters) typically depends on the individual data set and intended use of the results. In one embodiment of the present invention, a modified density based clustering process can be used. Such a modified process includes the steps of calculating the heat value of each data point by (i) counting the number of neighbor data points within a predetermined radius r (e.g. 20 km, a relatively long distance for human mobility) of the current data point, and (ii) calculating the heat value y for the current data point using a uniform kernel function. There are multiple types of kernel functions that can be used. For the sake of speed, a uniform kernel of y=Σᵢ1 was selected (basically, counting how many neighbor points within radius r). Once the heat value y has been calculated for each data point, those data points that have a heat value greater than a predetermined threshold (e.g., 10) can be identified as a Potential Cluster Center (FCC). This threshold is set according to the expected density in the cluster. For instance, if r=20 in the above equation, a threshold of 10 can be reached if there are 10 neighbors within the 20 km radius. In the clustering stage, first one cluster is created for each PCC, and all its neighbor points are assigned to the cluster. Second, if a PCC is within the r radius to another PCC, then the two clusters they belong to will be merged. The PCCs of the previous clusters then becomes the PCCs of the merged cluster. The clustering process stops when there are no clusters can be merged. It should be understood that the clustering process used is not limited to the above described process, and any clustering process can be utilized as part of the present invention.

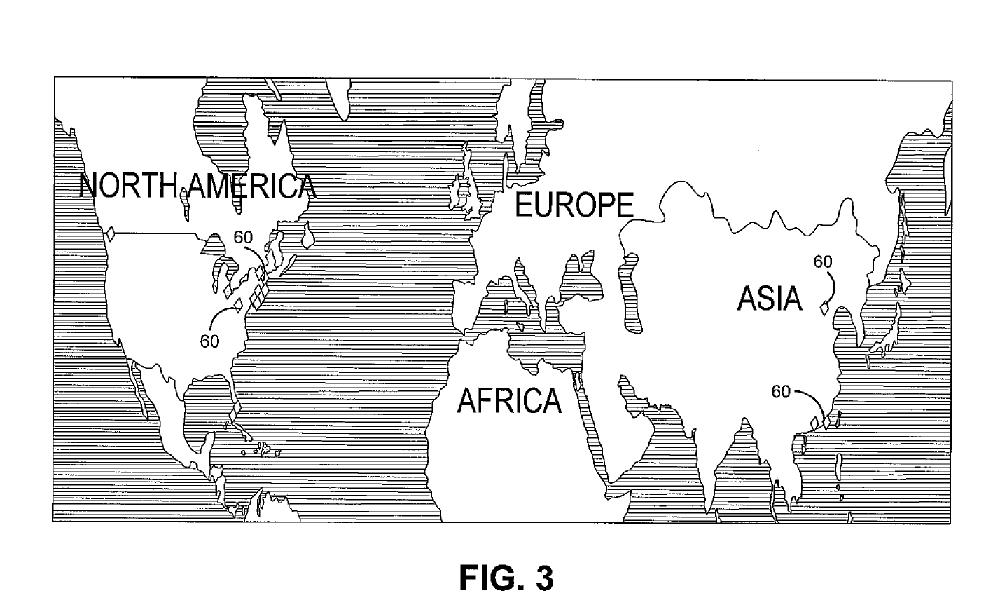

Once the clustering process has been performed, the result will provide several location clusters of a person. Location points close to each other (e.g., within one residential area, along one street, etc.) are usually clustered together while remote locations (New York vs. Toronto) are usually separated into different clusters. FIG. 3 shows an example of clustering results of a person's Foursquare check-in histories globally. As shown, there are multiple location clusters, represented by the diamond shapes 60, in both the United States and China. Each of the location clusters can include multiple data points within those clusters

Using the clustering results from step 52, in step 54 the computer system 10 next identifies a “home” area and a “travel” area by time filtering. The processing performed in step 54 will identify a person's “home” clusters, defined as where one regularly lives and works, from these several clusters. To do this, the longevity and frequency of the person's location history data points (also referred to as check-in records) are used as key filters. Thus, within each cluster, the longevity of a cluster and frequency of a cluster are determined by the computer system 10 using the following equations:
(1) Longevity of a cluster=the most recent data point time within this cluster minus the oldest data point time within this cluster.
(2) Frequency of a cluster=the longevity of the cluster divided by the total number of data points (i.e., check-ins) in this cluster.

Using the results from these calculations, a cluster is defined as a “home” area cluster if the following is true: (i) the longevity of a cluster is greater than or equal to one-half of the longevity of the total check-in history, i.e., if person has used check-in for 200 days, the time of his/her most recent check-in minus the time of his/her earliest check-in should be greater than or equal to 100 days, and (ii) the frequency of check-ins in this cluster is greater than the average frequency of the total check-in history multiplied by an adjustment factor (to ensure that this cluster is a cluster in which the user regularly checked-in. An exemplary adjustment factor that generates satisfactory results is 0.7. Any cluster that meets the requirements of equations (1) and (2) above is identified as a home area cluster, while those clusters that do not are identified as a travel area clusters. Once a home area and travel areas have been identified for a consumer, this information can be used by marketers in various ways. For example, a travel company can identify where a person lives and where he/she prefer to go for vacation from these results. A local grocery store may only want to market to persons who are local.

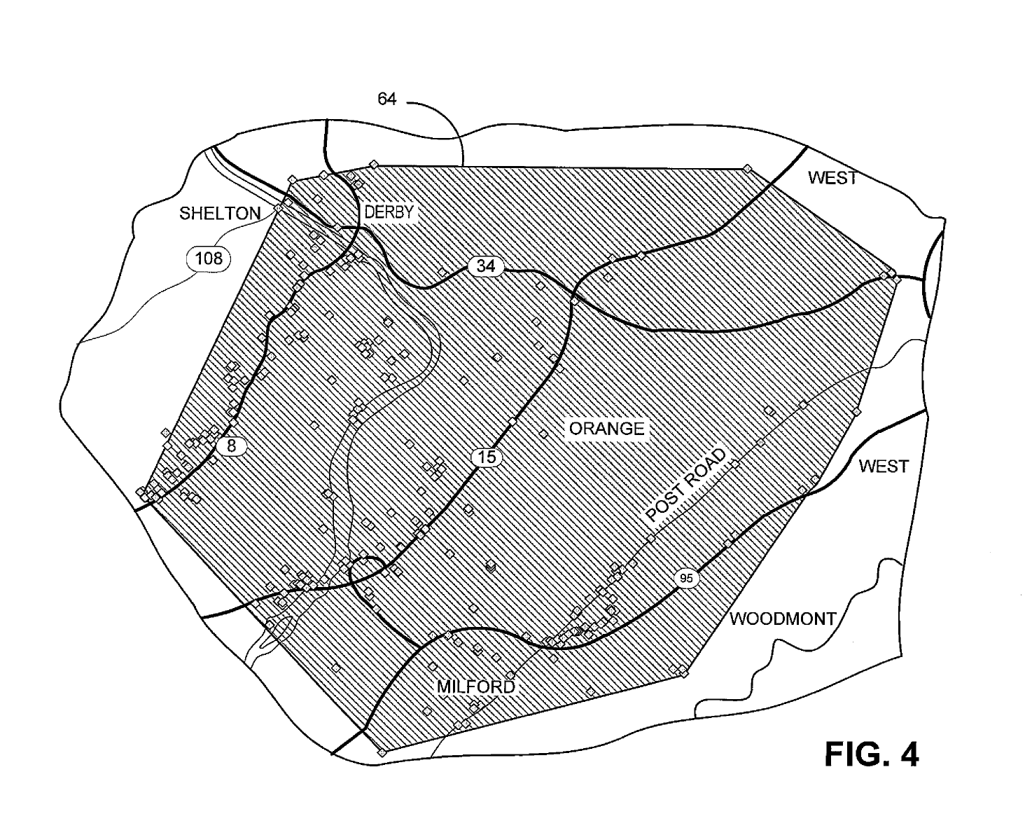

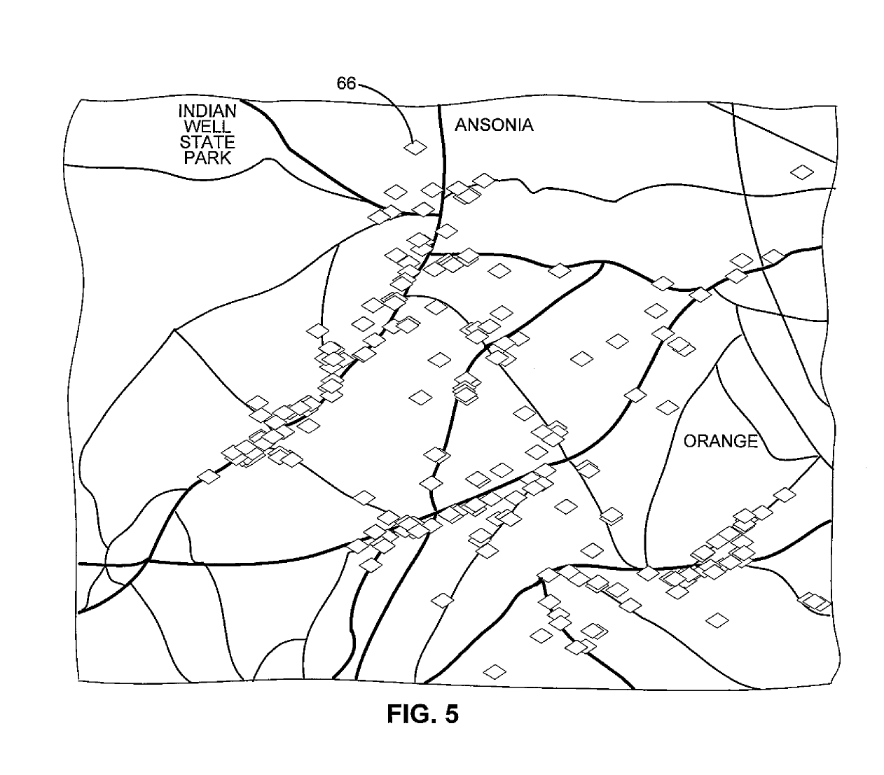

Once a home cluster has been identified, then in step 56 a convex hull polygon of all the points in this cluster is generated. The convex hull or convex envelope of a set X of points is the smallest convex set that contains X. An object is convex if for every pair of points within the object, every point on the straight line segment that joins them is also within the object. The resulting polygon is defined as the “home area” polygon. FIG. 4 illustrates an example of a home area polygon 64 for a person whose home area is in Connecticut. After a home area polygon 64 has been generated, then in step 58, potential places within this home area polygon where this person lives and works are identified. These further detailed analyses could be very useful for mobile marketing as described below. Determining these potential places includes detecting “hot spots” using a similar process as described with respect to step 52, but with a much smaller radius, e.g., 0.8 km. Thus, for each data point in the home polygon area, the heat value is calculated by (i) counting the number of data points within an area around a certain data point defined by a second radius that is preferably small, e.g., 0.8 km, and (ii) calculating the heat value y for the current data point using a triangle kernel function: y=Σᵢ(1−xᵢ/r), where xᵢ is the distance between the current data point and its i^{th} neighbor data point. Once the heat value has been calculated for each data point, those data points that have a heat value greater than a predetermined threshold (e.g., 10) can be identified as a potential place of living or working. For each potential place, all data points within the second radius distance, e.g., 0.8 km, are added as cluster members. Any two cluster centers that are closer than twice the second radius distance and all their members are combined into one cluster. Thus, the results are a set of small clusters with their hottest centroid points. FIG. 5 illustrates an example of a heat map, using the home area polygon 64 illustrated in FIG. 4, that includes data points represented by diamond 66 (only one is marked for clarity). It should be understood that the clustering process used is not limited to the above described process, and any clustering process can be utilized as part of the present invention.

Next, the hottest point is defined as the “overall” activity centroid of this person. A time filtering process is then utilized to further define the clusters as a living place or working place. The cluster with highest number of data points having a time (check-in) within regular working hours, which can be defined, for example, as being between 9 am and 5 pm during weekdays, can be labeled as the working cluster and its hottest point as the working centroid. Note this point may not necessarily be the actual office location of the person, but instead it could be a nearby coffee shop or lunch place. The cluster with highest number of data points having a time (check-in) within non-working hours, which can be defined, for example, as being between 8 pm and 5 am on weekdays plus all weekends, can be labeled as the living cluster, which is usually where a person lives. Note that it is possible for the living cluster to be the same as the working cluster. Additionally, the overall activity centroid is usually either the centroid of the living cluster or the working cluster. The resulting determinations can then be output by the computer system 10 in the form of a printed or displayed report.

From the processes above, it is possible to obtain one overall activity centroid of a person or multiple activity centroids with different context labels. These clusters and centroids can be used in various context aware mobile marketing campaigns. For instance, a business can send home-related advertisements to a person at their home location, and send work related advertisements to a person at their work location.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for determining a living and working area for a person, the method comprising:
receiving, by a processing device, a plurality of location history data points for the person from at least one of a social media service provider and a mobile telephone carrier service provider;
clustering, by the processing device, the plurality of location history data points using a first clustering radius to provide at least one location cluster for the person;
identifying, by the processing device, a home area cluster for the person from the at least one location cluster based on longevity and frequency of the location history data points included in each of the at least one location cluster;
generating, by the processing device, a home area polygon for the location history data points included in the home area cluster;
clustering, by the processing device, the location history data points in the home area polygon using a second clustering radius that is less than the first clustering radius to provide at least one home area location cluster for the person; and
determining, by the processing device, at least one of a living area and working area for the person from the at least one home area location cluster by applying a time filter to each of the at least one home area location cluster.

2. The method of claim 1, wherein clustering, by the processing device, the plurality of location history data points using a first clustering radius to provide at least one location cluster for the person further comprises:
calculating, by the processing device, a heat value of each location history data point by counting a number of data points within the first radius from each location history data point and calculating the heat value for each location history data point using a triangular kernel function; and
identifying, by the processing device, those data points that have a heat value greater than a predetermined threshold as a potential cluster center.

3. The method of claim 2, further comprising:
combining into a single cluster all potential cluster centers and data points within those potential cluster centers that are closer than twice the first radius.

4. The method of claim 1, wherein identifying, by the processing device, a home area cluster for the person from the at least one location cluster based on longevity and frequency of the location history data points included in each of the at least one location cluster further comprises:
determining, by the processing device, that a specific location cluster of the at least one location cluster is a home area cluster if the longevity of the specific location cluster is greater than or equal to one-half of the longevity of all of the at least one location clusters and the frequency of the specific cluster is greater than the frequency of all of the at least one location clusters multiplied by an adjustment factor.

5. The method of claim 4, further comprising:
determining, by the processing device, that a specific location cluster of the at least one location cluster is a travel area cluster if the specific location cluster is not a home area cluster.

6. The method of claim 1, wherein determining, by the processing device, at least one of a living area and working area for the person from the at least one home area location cluster by applying a time filter to each of the at least one home area location cluster further comprises:
determining, by the processing device, a specific cluster of the least one home area location cluster that has a highest number of data points having a time that is during non-working hours to be a living area for the person.

7. The method of claim 1, wherein determining, by the processing device, at least one of a living area and working area for the person from the at least one home area location cluster by applying a time filter to each of the at least one home area location cluster further comprises:
determining, by the processing device, a specific cluster of the least one home area location cluster that has a highest number of data points having a time that is during working hours to be a working area for the person.

8. The method of claim 1, wherein the location history data points include longitude and latitude coordinates.

9. The method of claim 1, wherein the location history data points include an address, and the method further comprises geocoding the address into a longitude and latitude coordinate.

10. A system for determining a living and working area for a person, the system comprising:
a processing device, the processing device being adapted to cluster a plurality of location history data points received from at least one of a social media service provider and a mobile telephone carrier service provider using a first clustering radius to provide at least one location cluster for the person; identify a home area cluster for the person from the at least one location cluster based on longevity and frequency of the location history data points included in each of the at least one location cluster; generate a home area polygon for the location history data points included in the home area cluster; cluster the location history data points in the home area polygon using a second clustering radius that is less than the first clustering radius to provide at least one home area location cluster for the person; and determine at least one of a living area and working area for the person from the at least one home area location cluster by applying a time filter to each of the at least one home area location cluster.

11. The system of claim 10, wherein the processing device is adapted to cluster the plurality of location history data points using a first clustering radius to provide at least one location cluster for the person by calculating a heat value of each location history data point by counting a number of data points within the first radius from each location history data point and calculating the heat value for each location history data point using a triangular kernel function; and identify those data points that have a heat value greater than a predetermined threshold as a potential cluster center.

12. The system of claim 10, wherein the processing device is adapted to identify a home area cluster for the person from the at least one location cluster based on longevity and frequency of the location history data points included in each of the at least one location cluster by determining that a specific location cluster of the at least one location cluster is a home area cluster if the longevity of the specific location cluster is greater than or equal to one-half of the longevity of all of the at least one location clusters and the frequency of the specific cluster is greater than the frequency of all of the at least one location clusters multiplied by an adjustment factor.

13. The system of claim 10, wherein the processing device is adapted to determine that a specific cluster of the least one home area location cluster that has a highest number of data points having a time that is during non-working hours is a living area for the person.

14. The system of claim 13, wherein the processing device is adapted to determine that a specific cluster of the least one home area location cluster that has a highest number of data points having a time that is during working hours is a working area for the person.

15. A non-transitory computer readable medium comprising instructions, which when executed on a processing device, cause the processing device to determine at least one of a living and working area for a person by clustering a plurality of location history data points for the person received from at least one of a social media service and a mobile telephone carrier service using a first clustering radius to provide at least one location cluster for the person; identifying a home area cluster for the person from the at least one location cluster based on longevity and frequency of the location history data points included in each of the at least one location cluster; generating a convex hull polygon for the location history data points included in the home area cluster; clustering the location history data points in the convex hull polygon using a second clustering radius that is less than the first clustering radius to provide at least one home area location cluster for the person; and determining at least one of a living area and working area for the person from the at least one home area location cluster by applying a time filter to each of the at least one home area location cluster.
